(19) United States
(12) Patent Application Publication
(10) Pub. No.: US 2007/0240887 A1
(43) Pub. Date: Oct. 18, 2007

(54) FIRE SUPPRESSION SYSTEM

(76) Inventors: JO ANN P. HOWETH, Flower Mound, TX (US); Walter T. Myers SR., Kerrville, TX (US)

Correspondence Address: NICK A NICHOLS, P O BOX 16399, SUGARLAND, TX, 774966399, US

(21) Appl. No.: 11/279,940

(22) Filed: Apr. 17, 2006

(51) Int. Cl. A62C 3/00

(52) U.S. Cl. 169/65; 169/75; 239/548

(57) ABSTRACT

An improved fire extinguishing system for residential and commercial cook stoves and ranges includes one or more heat and/or smoke sensors connected to a control circuit. A cut-off switch activated by the heat and/or smoke sensors is provided to interrupt the flow of gas or electric power to the cook stove burners. The burners are in fluid communication with a source of a fire suppressant. Upon sensing a fire on the cook stove, fluid communication is established between the burners and fire suppressant for rapidly cooling the burners and extinguishing the fire.

### BACKGROUND OF THE INVENTION

The present invention relates to a fire suppression system for a stove or cooktop. More particularly, this invention relates to an automatically actuated fire suppression system and method for extinguishing a fire and rapidly cooling a stovetop burner by dispensing a fire suppressant and coolant on the burner and the cookware thereon, such as pot, skillet, or the like.

Many residential and commercial fires originate in the kitchen. Overheated greases or oils during cooking can easily ignite resulting in a potentially dangerous fire, particularly if the pot or skillet on the cook stove is not being attended. Exhaust hoods are commonly installed above stoves. The exhaust hoods typically include a fan and some are equipped with fire suppression equipment.

These fire extinguishing systems however have disadvantages. In those systems where the fire suppression equipment is mounted in the exhause hood, the fire suppression material is released from above and sprayed on the stove, the countertop and any other equipment and materials located on the countertop creating a bigger mess than may be necessary to extinguish the fire.

It is therefore an object of the present invention to provide a fire suppression system for residential and commercial cook stoves which senses the location of a fire and delivers a fire suppressant to the affected burner or burners.

### SUMMARY OF THE INVENTION

In accordance with the present invention, an improved fire suppression system for residential and commercial cook stoves includes one or more heat and/or smoke sensors connected to a control circuit. A cut-off switch activated by the heat and/or smoke sensors is provided to interrupt the flow of gas or electric power to the cook stove burners.

In accordance with a preferred embodiment of the invention, the burners for an electric cook stove include an elongated heating element provided with a channel extending therethrough and a plurality of passageways extending from the channel to the outer surface of the heating element. The heating element is operatively connected to a fire suppressant source. Upon sensing a fire on the cook stove, the sensors actuate a valve placed between the burners and the fire suppressant source which opens permitting the fire suppressant to flow through the heating element channel and holes to rapidly cool the heating element and extinguish the fire.

In accordance with another embodiment of the present invention, a multi-port valve is incorporated in the gas line to a gas operated stove. Upon sensing a fire, the multi-port valve is actuated by the sensors to interrupt the flow of gas to the burners of the stove and open the flow of fire suppressant to the burners.

In accordance with another embodiment of the present invention, a glass cooktop is provided with a plurality of nozzles aligned along each side of the cooktop burners. The nozzles are angled toward the burners and are operatively connected to a fire suppressant source via a multi-port valve. Upon sensing a fire, the multi-port valve is actuated by the sensors to interrupt the flow of gas or electric power to the burners and open the flow of fire suppressant to the burners.

### BRIEF DESCRIPTION OF THE DRAWINGS

So that the manner in which the above recited features, advantages and objects of the present invention are attained can be understood in detail, a more particular description of the invention briefly summarized above, may be had by reference to the embodiments thereof which are illustrated in the appended drawings.

It is noted, however, that the appended drawings illustrate only typical embodiments of this invention and are therefore not to be considered limiting of its scope, for the invention may admit to other equally effective embodiments.

FIG. 1 is a pictorial view of a conventional residential cook stove;

FIG. 2 is a top view of a heating element of the present invention;

FIG. 3 is a section view taken along line 3-3 of FIG. 2;

FIG. 4 is a perspective view of a heating element terminal block of the present invention;

FIG. 5 is a section view taken along line 5-5 of FIG. 2;

FIG. 6 is a block diagram illustration the components of the present invention;

FIG. 7 is a partially broken away top view illustrating another embodiment of the present invention; and

FIG. 8 is a top view illustrating another embodiment of the present invention.

### DETAILED DESCRIPTION OF A PREFERRED EMBODIMENT

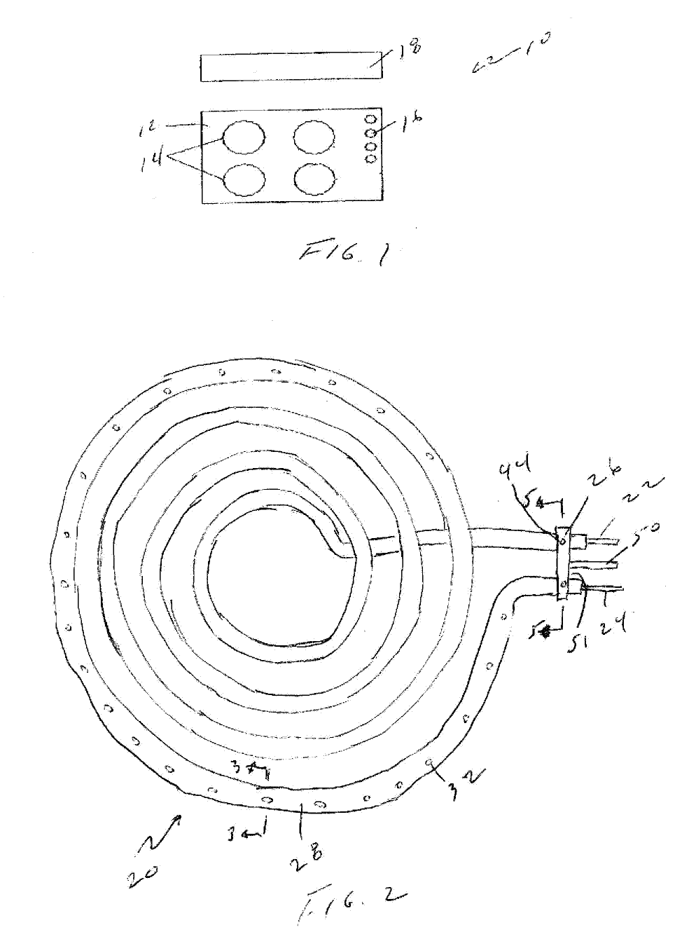

Referring first to FIG. 1, a preferred embodiment of the fire suppression system of the invention may be retrofit into an existing stove or incorporated in a new stove. An exemplary stove generally identified by the reference numeral 10 includes a stovetop 12, burners 14 and other components, such as control knobs 16. A vent hood 18 is typically mounted above the stovetop 12.

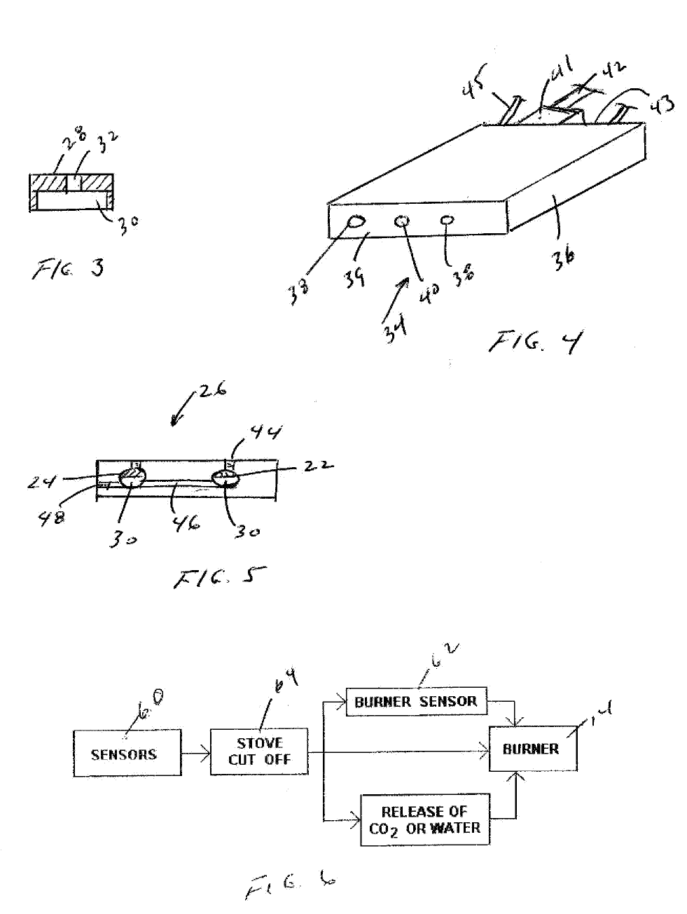

Referring now to FIG. 2, the burners 14 of the present invention include an electric heating element 20. It is understood, however, that the burners 14 may be gas or electric. The heating element 20 comprises an elongated coiled body terminating at ends 22 and 24. The ends 22 and 24 of the heating element 20 are substantially parallel and are retained in spaced relationship by a spacer bracket 26 secured proximate the ends 22 and 24. The heating element 20 includes a substantially planar top surface 28 defining a substantially flat heating surface. A channel 30, as best shown in FIG. 3, is formed in the heating element 20 below the top surface 28 and extends the full length thereof and terminating at the heating element ends 22 and 24. The heating element 20 includes a plurality of substantially equally spaced holes 32 extending between the top surface 28 and the channel 30 thereof.

Referring now to FIG. 4, a terminal block 34 of the invention is shown. The terminal block 34 comprises a substantially solid body 36 fabricated of plastic, ceramic or other suitable materials. A terminal block 34 is mounted below the stovetop 12 adjacent each burner 14. Electrical receptacles 38, sized to receive the ends 22 and 24 of the heating element 20, extend inwardly from a forward end 39 of the terminal block 34. The receptacles 38 are connected to electrical wiring 45 extending from an opposite end 43 of the terminal block 34. The wiring 45 is connected to an electric power source, such as the home or building electrical circuit. The receptacles 38 form part of a control circuit for supplying power to the heating coil 20.

Referring still to FIG. 4, the terminal block 34 includes an axial passage 40 extending through the body 36 thereof. The passage 40 extends from the forward end 39 of the terminal block 34 to the opposite end 43 thereof. The passage 40 is internally threaded proximate the end 43 of the terminal block 34 for connecting a valve 41, such as an electronic solenoid valve or the like, thereto. A conduit 42 connects the valve 41 to a fire suppressant source.

Referring again to FIG. 2, the spacer bracket 26 is secured to the heating element 20 by set screws 44 or the like. As best shown in FIG. 5, the spacer bracket 26 includes a horizontally disposed passage 46. Upon securing the bracket 26 to the heating element 20, the passage 46 is aligned in fluid communication with the channel 30 of the heating element 20. The passage 46 is closed by a plug 48 threaded or otherwise secured to an end thereof.

An axially hollow quick connect fitting 50 fixedly secured to the spacer bracket 26 projects from the rear face 51 thereof. The fitting 50 is open at both ends thereof, with one end opening into the passage 46 of the spacer bracket 26. The opposite end of the fitting 50 is sized for insertion into the passage 40 of the terminal block 34 for sealing engagement therewith upon plugging the heating element 20 into the terminal block 34. O-ring seals or the like internally located in the passage 40 of the terminal block 34 form a fluid tight seal about the fitting 50.

The heating element 20 may be retrofit in an existing stove or cooktop. The retrofit requires removal of the existing heating element terminal block and installing a terminal block 36 and valve 41 of the present invention below the stovetop 12 adjacent each of the burners 14. The conduit 42 is then connected to the valve 41 and the opposite end thereof to a fire suppressant source. In a preferred embodiment, the fire suppressant is pressurized soda water or CO₂ contained in a canister (not shown in the drawings) mounted in a convenient location, such as below the stovetop 12. It is understood, however, that other suitable fire suppressants may also be used. The heating element 20 is installed by inserting the ends 22,24 thereof and fitting 50 of the bracket 26 into the receptacles 38 and passage 40 of the terminal block 36.

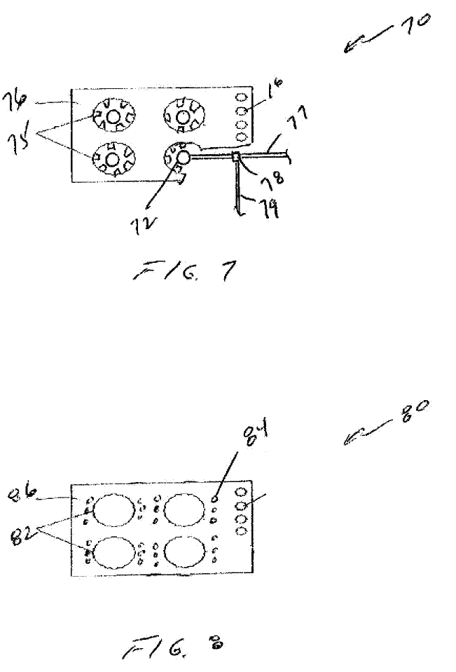

Referring now to the diagram of FIG. 6, the control circuit for activating the fire suppression system of the present invention upon detecting excessive heat and/or smoke from the stovetop 12 is illustrated. For a stove 10 equipped with a vent hood 18, one or more fire and smoke sensors 60 are mounted in the hood vent 18 above the stovetop 12. Burner sensors 62 are mounted proximate each of the burners 14. Upon sensing excessive smoke and/or heat, the sensors 60 activate a cut off switch 64 terminating the supply of electric power to the burners 14. The burner sensors 62 then open the solenoid valve 41 associated with the overheated or active burner 14. When the valve 41 is opened, soda water or CO₂ is released and routed through the channel 30 and holes 32 of the heating element 20 to engulf the burner 14. The soda water or CO₂ quickly cools the heating element 20 and the overheated cookware, including any burning contents in the cookware.

Referring now to FIG. 7, another embodiment of the fire suppression system of the present invention is shown. The embodiment of FIG. 7 is substantially the same as the embodiment of FIGS. 2-5 described hereinabove with the exception that the invention is applied to a gas stove 70. The stove 70 includes one or more gas burners 72 and grates 75 supported on the stovetop 12 above the burners 72. The burners 72 are operatively connected to a gas line 77 which supplies gas to the burners 72 in a well known manner. A multi-port valve 78 incorporated in the gas line 77 is connected to a soda water or CO₂ supply line 79. The valve 78 is actuated by the burner sensors 62 to shut off the gas line 77 and open the soda water or CO₂ line 79 in the event of a fire on the stove 70. The fire is smothered and put out in the manner described hereinabove.

Referring now to FIG. 8, another embodiment of the fire suppression system of the present invention is shown. The embodiment of FIG. 8 is substantially the same as the embodiment of FIGS. 2-5 described hereinabove with the exception that the invention is applied to a glass cooktop 80. The cooktop 80 includes one or more burners 82. A plurality of nozzles 84 are aligned along each side of the burners 82. The nozzles 84 extend through the cooktop surface 86 at an angle of about 45° toward the burners 82. The distal ends of the nozzles 84 are flush with the cooktop surface 86. The nozzles 84 are operatively connected to a soda water or CO₂ supply via a multi-port valve. In the event of a fire, the gas or power supply to the burners 82 is cut off and the multi-port valve is actuated to route soda water or CO₂ to the burners 82 to smother and put out the fire in the manner described hereinabove.

While a preferred embodiment of the invention has been shown and described, other and further embodiments of the invention may be devised without departing from the basic scope thereof, and the scope thereof is determined by the claims which follow.

1. A system for extinguishing a fire adapted for use with a stove or cooktop, comprising:
a) a stovetop having one or more burners and control knobs operatively connected to a power source;
b) at least one sensor for detecting the occurrence of a fire at one or more of said burners; and
c) a source of fire suppressant in fluid communication with said burners.

2. The system of claim 1 wherein said burners include a heating element having a channel extending therethrough and a plurality of passageways extending between said channel and an outer surface of said heating element.

3. The system of claim 2 wherein said heating element is selectively connected to said fire suppressant source.

4. The system of claim 3 including a valve operatively connected to said at least one sensor and said heating element, and wherein upon detection of a fire on said stovetop said at least one sensor actuates said valve to an open position.

5. The system of claim 1 wherein said at least one sensor is operatively connected to a shut-off switch for interrupting the connection of said burners to said power source.

6. The system of claim 1 wherein said fire suppressant is soda water.

7. The system of claim 1 wherein said fire suppressant is CO₂.

8. The system of claim 1 including a sensor located proximate each of said burners.

9. The system of claim 1 wherein said at least one sensor is located in an exhaust hood over said stovetop.

10. The system of claim 4 wherein said heating element comprises an elongated coiled body having terminal ends adapted for snap-in connection to a terminal block mounted on said stovetop.

11. The system of claim 10 including a spacer bracket connected proximate said terminal ends of said heating element, said spacer bracket retaining said terminal ends of said heating element in a substantially parallel spaced relationship.

12. The system of claim 11 wherein said spacer bracket includes a passage adapted for alignment with said channel of said heating element, and further including a quick connect fitting for establishing fluid communication between said heating element and said fire suppressant.

13. The system of claim 1 including a plurality of nozzles mounted in said stovetop and aligned adjacent said burners, wherein said nozzles are angled toward said burners and in the fluid communication with said source of fire suppressant.

14. The system of claim 13 wherein said nozzles are angled toward said burners at an angle of about 45°.

15. The system of claim 4 wherein said valve is a multi-port solenoid valve.
